(19) United States
(12) Patent Application Publication
(10) Pub. No.: US 2006/0047667 A1
(43) Pub. Date: Mar. 2, 2006

(54) System and method for data interchange

(75) Inventor: Chi-Hung Hou, Fullerton, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry Co., LTD., Tu-Cheng City (TW)

(21) Appl. No.: 11/210,362

(22) Filed: Aug. 24, 2005

(30) Foreign Application Priority Data
Aug. 27, 2004 (TW) 93125729

(51) Int. Cl. G06F 17/30

(52) U.S. Cl. 707/10

(57) ABSTRACT

A system and method for data interchange between a local system and a remote system is disclosed. Each of the local system and the remote system has an application server, a database server and a plurality of client computers. The application server is for filtering data interchange requests and accelerating data interchange. Each data interchange request is Http (Hypertext Transfer Protocol) triggered and transferred in XML (Extensible Markup Language) format. The method for data interchange includes the steps of: sending a request for transmitting new data to a remote database server; submitting the request to a local database server; sending the new data to a local application server; transforming the new data to an XML format; sending the new data to the remote application server.

### BACKGROUND OF THE INVENTION

1. Field of the Invention

The present invention relates generally to systems and methods for data interchange, and more particularly, to a system and method for data interchange in real-time between distributed systems.

2. General Background

For multinational companies set to develop business in different countries all over the world, transferring data between different subsidiary companies or between subsidiary companies and the headquarter becomes more and more important. One solution of data interchange is shown in FIG. 1: a local client computer 10 sends data to a local database server 11 in a local system 1, and the local database server 11 saves the data in a local database 12 (step S11); a remote application server 23 in a remote system 2 sends data interchange requests daily at fixed times to the local database server 11 to get the saved data (step S12); the local database server 11 sends the data to the remote application server 23 (step S13); the remote application server 23 transforms the data to an XML (Extensible Markup Language) format, and sends the data to a remote database server 21 (step S14); a remote client computer 20 sends a request for the data to the remote database server 21 (step S15); the remote database server 21 sends the data to the remote client computer 20.

Another solution for data interchange between distributed systems is illustrated in FIG. 2. In step S21, a local client computer 10 in a local system 1 sends data to a local database server 11, and the local database server 11 saves the data in a local database 12. In step S22, the local database server 11 sends the data daily at fixed times by FTP (File Transportation Protocol) to a remote application server 23 in a remote system 2. In step S23, the remote application server 23 saves the data in a remote database server 21. In step S24, a remote client computer 20 sends a request for the data to the remote database server 21. In step S25, the remote database server 21 sends the data required to the remote client computer 20.

However, both the above two solutions need corresponding the local application server to send the data to the remote database server daily at fixed times. Furthermore, the local database server is directly connected to the remote application server in the remote system, resulting in the situation of bad data access introductions overburdening the local database server.

Therefore, a system and method for data interchange in real-time between distributed systems is desired.

### SUMMARY

A system for data interchange between a local system and a remote system is provided in accordance with a preferred embodiment of the present invention. Each of the local system and the remote system provides a plurality of client computers, a database server, an application server, and a database. The application server includes: a basic parameter setting module for setting basic parameters of a local application server, the basic parameters including an address of the local application server, database connection parameters, a maximum time for rerunning when an error occurs during data interchange; a remote address setting module for setting an address, an ID (Identification) and a URL (Uniform Resource Locater) of a remote application server; a request receiving module for receiving a request for data interchange from the remote application server; a data receiving module for receiving data from a local database server and transforming the received data to an XML format; a data sending module for sending the data to the remote application server; and a data checking module for checking the data to determine whether the contents and format of the data are correct.

A method for data interchange between a local system and a remote system is provided in accordance with another embodiment of the present invention. The method includes the steps: setting basic parameters of a local application server; setting basic parameters including an address, a URL and an ID of a remote application server; saving new data to a local database; sending a request for transmitting the new data to the local application server; submitting the request to a local database server; sending the new data to the local application server; transforming the new data to an XML format; sending the new data to the remote application server; checking the new data to determine whether the contents and format of the received data are correct; saving the correct new data to a remote database; and sending the correct new data to a remote client computer.

Other advantages and novel features of the invention will become more apparent from the following detailed description when taken in conjunction with the accompanying drawings, in which:

### BRIEF DESCRIPTION OF THE DRAWINGS

FIG. 1 is a schematic diagram of hardware configuration of a solution for data interchange;

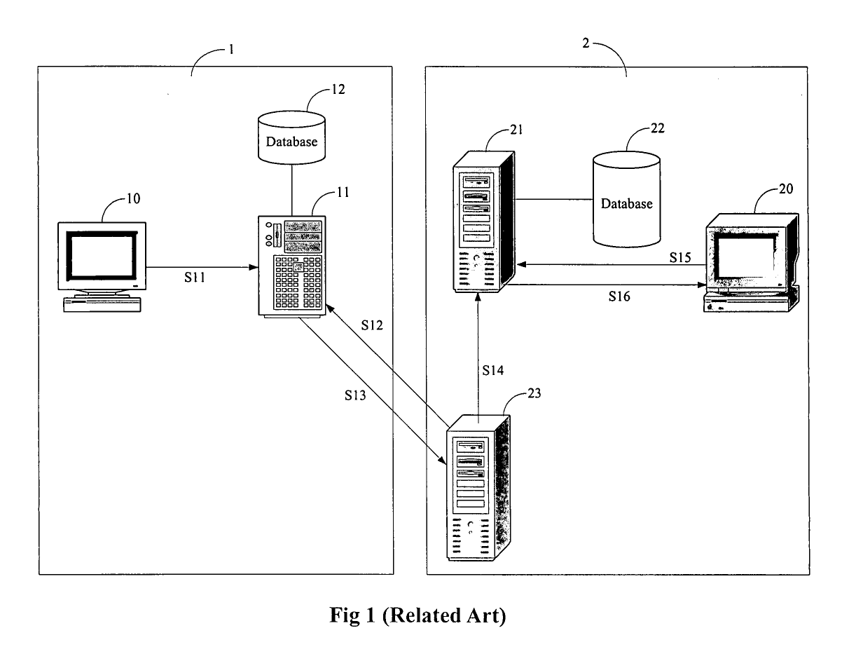

FIG. 2 is a schematic diagram of hardware configuration of another solution for data interchange;

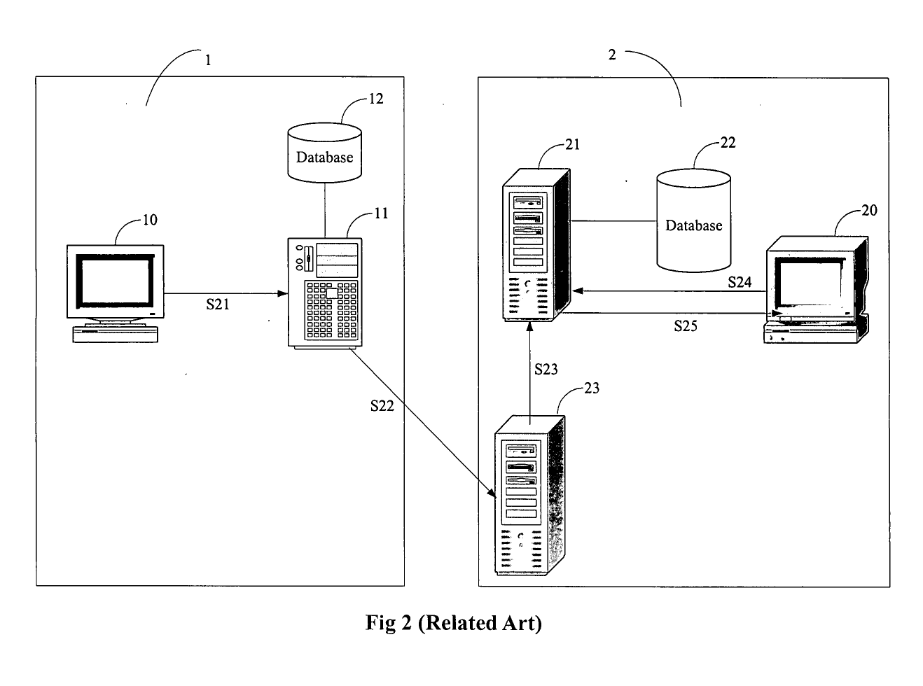

FIG. 3 is a schematic diagram of hardware configuration of a system for data interchange in accordance with a preferred embodiment of the present invention;

FIG. 4 is schematic diagram illustrating function modules of an application server; and

FIG. 5 is a flowchart of a preferred method for data interchange between a local system and a remote system.

### DETAILED DESCRIPTION OF THE INVENTION

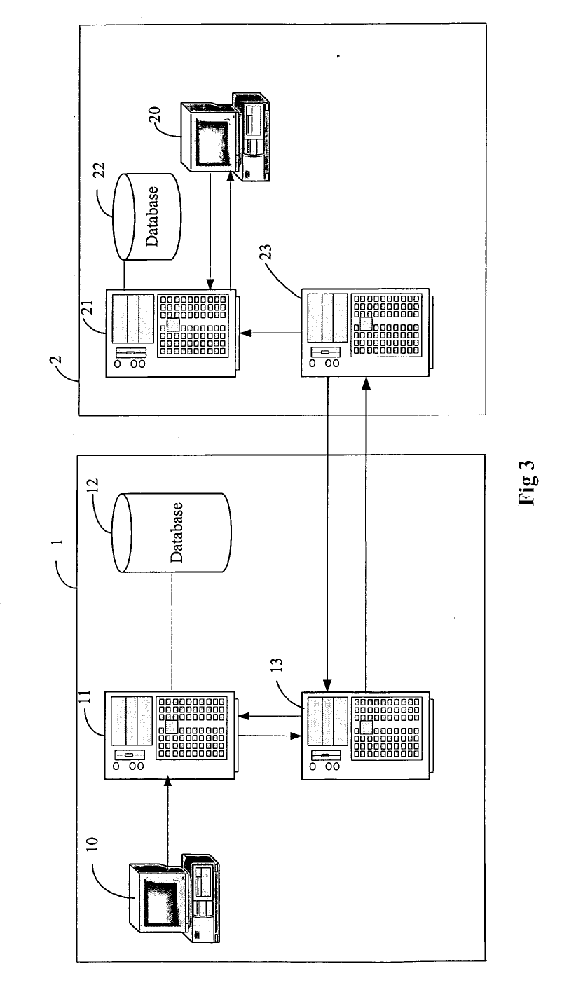

FIG. 3 is a schematic diagram of hardware configuration of a system for data interchange in accordance with a preferred embodiment of the present invention. The system for data interchange includes a local system 1 and at least one remote system 2. The local system 1 includes: a local database server 11; a local database 12 connected to the local database server 11 by a database connection, for storage of data interchanged between the local system 1 and the remote system 2; a local application server 13 connected with the local database server 11, for performing data interchange with the remote system 2; and a plurality of local client computers 10 (only one shown), for users to access data from the local database 12. The remote system 2 includes a remote database server 21; a remote database 22 connected to the remote database server 21 by a database connection, for storage of data interchanged between the local system 1 and the remote system 2; a remote application server 23 connected with the remote database server 21, for performing data interchange with the local system 1; and a plurality of remote client computers 20 (only one shown), for users to access data from the remote database 22. The local application server 13 is connected to the remote application server 23 by the Internet or a Wide Area Network.

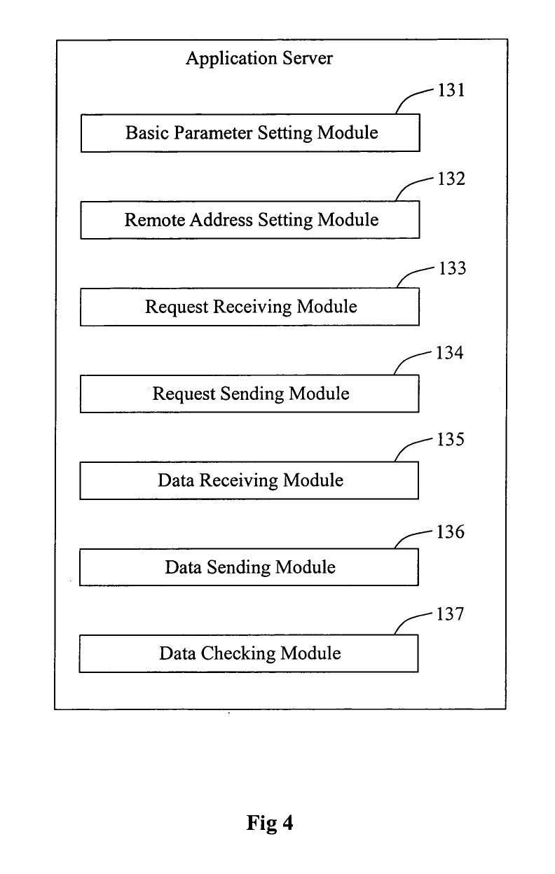

FIG. 4 is a schematic diagram illustrating function modules of an application server. It is recommended that all local application servers and remote application servers should be installed the function modules described below: a basic parameter setting module 131 for setting basic parameters of an local application server 13, including an address of the local application server 13, database connection parameters, a limit time for rerunning when an error occurs during data interchange, etc.; a remote address setting module 132 for setting an address, an ID (Identification) and a URL (Uniform Resource Locater) of a remote application server; a request receiving module 133 for receiving a request for data interchange from the remote application server; a request sending module 134 for submitting the request to the local database server 11; a data receiving module 135 for receiving data from a corresponding local database server and transforming the received data to an XML format; a data sending module 136 for sending the data to the remote application server; a data checking module 137 for checking the data to determine whether the contents and format of the data are correct. Each data interchange request is Http (Hypertext Transfer Protocol) triggered and transferred in XML (Extensible Markup Language) format.

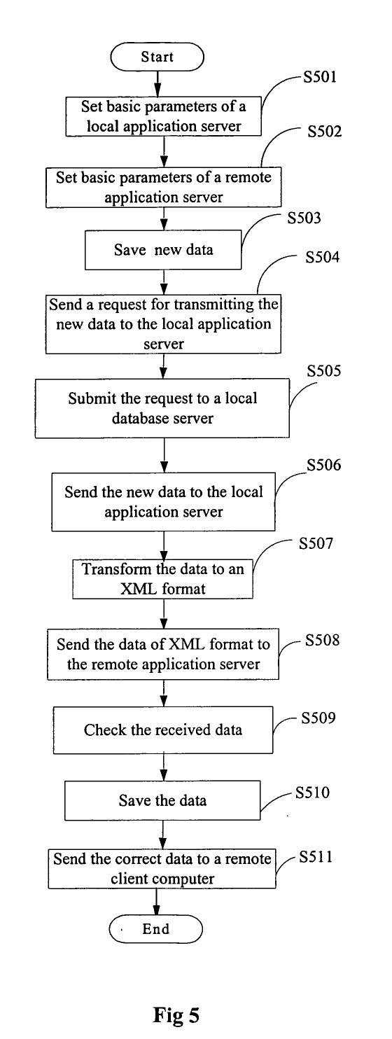

FIG. 5 is a flowchart of a preferred method for data interchange by utilizing the system of FIG. 3. In step S501, the basic parameter setting module 131 of the local application server 13 sets basic parameters of the local application server 13, including an address of the local application server 13, database connection parameters, a limit time for rerunning when an error occurs during data exchange, etc. In step S502, the remote address setting module 132 sets basic parameters including an address, a URL and an ID of the remote application server 23. When the local system 1 needs to transmit new data to the remote system 2, in step S503, the local database server 11 saves the new data to the local database 12. Then in step S504, the remote client computer 20 sends a request for transmitting the new data to the remote database server 21. The remote database server 21 transmits the request to the remote application server 23. The remote application server 23 finally sends the request to the local application server 13. In step S505, the request receiving module 133 in the local application server 13 receives the request, and the request sending module 134 submits the request to the local database server 11. In step S506, the local database server 11 obtains the new data from the local database 12, and sends the new data to the local application server 13. In step S507, the data receiving module 135 receives the new data and transforms the new data to an XML format. In step S508, the data sending module 136 sends the new data to the remote application server 23. In step S509, the data checking module 137 in the remote application server 23 checks the new data to determine whether the contents and format of the received data are correct. In step S510, the remote application server 23 sends the new data after being checked to the remote database server 21. The remote database server 21 saves the correct new data to the remote database 22. In step S511, the remote database server 21 sends the correct new data to the remote client computer 20, whereupon the procedure is finished.

While the invention has been described in terms of a single preferred embodiment, those skilled in the art will recognize that the invention can be practiced with modification within the spirit and scope of the appended claims.

We claim:

1. A system for data interchange comprising a local system and a remote system, each of the local system and the remote system providing a plurality of client computers, a database server, an application server, and a database, the application server comprising:
a basic parameter setting module for setting basic parameters of a local application server, the basic parameters including an address of the local application server, database connection parameters, a limit time for rerunning when an error occurs during data interchange;
a remote address setting module for setting an address, an ID (Identification) and a URL (Uniform Resource Locater) of a remote application server;
a request receiving module for receiving a request for data interchange from the remote application server;
a data receiving module for receiving data from a local database server and transforming the received data to an XML format;
a data sending module for sending the data to the remote application server; and
a data checking module for checking the data to determine whether the contents and format of the data are correct.

2. A method for data interchange between a local system and a remote system, comprising the steps of:
setting basic parameters of a local application server;
setting basic parameters including an address, a URL and an ID of a remote application server;
saving new data to a local database;
sending a request for transmitting the new data to the local application server;
submitting the request to a local database server;
sending the new data to the local application server;
transforming the new data to an XML format;
sending the new data to the remote application server;
checking the new data to determine whether the contents and format of the received data are correct;
saving the correct new data to a remote database; and
sending the correct new data to a remote client computer.

3. The method as claimed in claim 2, wherein the basic parameters of a local application server comprise: an address of the local application server, database connection parameters, and a limit time for rerunning when an error occurs during data interchange.

4. The method as claimed in claim 2, wherein the basic parameters of a remote application server comprise an address, an ID (Identification) and a URL (Uniform Resource Locater) of the remote application server.

5. A method for data interchange between a local system and a remote system, comprising the steps of:
providing a local database server in a local system for access of local users;
allowing communication of said local database server with a remote system through a local application server exclusively; and
retrieving data from said local database server to said remote system via said local application server based on a user request of said remote system transmitted from said remote system to said local application server.

6. The method as claimed in claim 5, wherein said user request of said remote system is a HyperText Transfer Protocol (HTTP) request.

7. The method as claimed in claim 5, wherein said user request of said remote system is real-time provided to said local application server per user's immediate need rather than on a daily fixed-time basis.

8. The method as claimed in claim 5, further comprising the step of setting basic parameters of said local application server including an address, a Uniform Resource Locater (URL) and an Identification (ID) of a remote application server of said remote system.

9. The method as claimed in claim 5, further comprising the step of transforming said data to an Extensible Markup Language (XML) format in said local application server before it is retrieved to said remote system.
